(19) United States
(12) Patent Application Publication
(10) Pub. No.: US 2022/0263417 A1
(43) Pub. Date: Aug. 18, 2022

(54) IMAGE FORMING APPARATUS

(71) Applicant: CANON KABUSHIKI KAISHA, Tokyo (JP)

(72) Inventor: Takumi Moriyama, Ibaraki (JP)

(21) Appl. No.: 17/669,009

(22) Filed: Feb. 10, 2022

(30) Foreign Application Priority Data
Feb. 17, 2021 (JP) 2021-023542

(51) Int. Cl. H02M 3/335; G03G 15/00

(52) U.S. Cl. CPC H02M 3/33571; G03G 15/80

(57) ABSTRACT

An image forming apparatus is provided that includes an image forming unit, a first controller configured to switch between a first power mode and a second power mode, and a power supply device. The power supply device includes a rectification unit, a smoothing capacitor, a transformer, a capacitor, a switching element, and a second controller. The second controller stops output of a pulse signal in a case where the voltage output from the power supply device is greater than a second voltage and a determined frequency is greater than a predetermined frequency, in the second power mode. The second controller starts the output of the pulse signal in a case where the voltage decreases and reaches the second voltage, in the second power mode.

### BACKGROUND

### Field

The present disclosure relates to an image forming apparatus including a power supply device that outputs a voltage.

### Description of the Related Art

Conventionally, there has been known a power supply device including an alternate current/direct current (AC/DC) converter circuit that converts an alternate-current voltage supplied from a commercial power source into a direct-current voltage. United States Patent Application Publication No. 2017/0176916 discusses a power supply device that converts an alternate-current voltage into a direct-current voltage by a current resonance method using a transformer.

In the current resonance method, for example, the transformer is driven by a half-bridge connected switching element. A frequency for driving the switching element contributes to an output voltage on the secondary side. In general, the frequency for driving the switching element is set to a predetermined frequency suitable for the characteristic of a circuit including the transformer, so that the output voltage does not fluctuate even if a load on the secondary side fluctuates.

In the configuration in which the frequency for driving the switching elements is set to the predetermined frequency, a load current corresponding to the magnitude of the load on the secondary side and an exciting current not depending on the magnitude of the load on the secondary side flow through a winding wire on the primary side of the transformer.

An image forming apparatus has a normal power mode in which image formation is performed and a power saving mode (sleep mode) in which power consumption is smaller than that in the normal power mode. In a case where the power supply device using the current resonance method is applied to the image forming apparatus, an exciting current of a magnitude greater than a desirable magnitude flows through the winding wire on the primary side of the transformer in the power saving mode. In other words, in the case where the power supply device using the current resonance method is applied to the image forming apparatus, the efficiency of the power supply device in the power saving mode is lower than the efficiency of the power supply device in the normal power mode.

United States Patent Application Publication No. 2017/0176916 discusses a configuration in which an exciting current is decreased in a case where the load on the secondary side is light. Specifically, there is discussed a configuration of switching between winding wires to be used on the primary side of the transformer based on the magnitude of the load on the secondary side. More specifically, there is discussed a configuration in which a winding wire for a heavy load is used as the winding wire on the primary side of the transformer in a case where the load on the secondary side is heavy, and a winding wire for a light load is used as the winding wire on the primary side of the transformer in a case where the load on the secondary side is light.

In United States Patent Application Publication No. 2017/0176916, a relay circuit is disposed in the circuit on the primary side of the transformer, and a control unit for controlling the relay circuit is disposed on the secondary side thereof in order to switch between the two types of winding wire disposed on the primary side of the transformer. Besides, the two types of winding wire are each disposed as the winding wire on the primary side of the transformer. These result in an increase in cost and an increase in the size of a power supply circuit.

### SUMMARY

Various embodiments of the present disclosure are directed to preventing a decrease in efficiency in an image forming apparatus, while preventing increases in the size and the cost of the image forming apparatus.

According to one embodiment of the present disclosure, an image forming apparatus includes an image forming unit configured to form an image on a recording medium, a first controller configured to switch between a first power mode in which image formation by the image forming unit is enabled and a second power mode in which a number of loads supplied with power is less than a number of loads in the first power mode and power consumption is less than power consumption in the first power mode, and a power supply device configured to convert an alternate-current voltage output from a commercial power source into a direct-current voltage, the power supply device including a rectification unit configured to rectify the alternate-current voltage output from the commercial power source, a smoothing capacitor configured to smooth the voltage rectified by the rectification unit, a transformer including a first winding wire to which the voltage smoothed by the smoothing capacitor is applied and a second winding wire insulated from the first winding wire, a capacitor connected to the first winding wire in series, a switching element connected to both the first winding wire and the capacitor in parallel, and a second controller configured to determine a frequency of a pulse signal for switching between an on state and an off state of the switching element and to output the pulse signal of the determined frequency, the pulse signal being a signal in which a signal at a first level and a signal at a second level are repeated, wherein the power supply device outputs a voltage based on a voltage generated in the second winding wire due to the voltage applied to the first winding wire, wherein the second controller decreases the frequency of the pulse signal in a case where the voltage output from the power supply device is smaller than a first voltage, and the second controller increases the frequency of the pulse signal in a case where the voltage output from the power supply device is greater than the first voltage, in the first power mode, wherein the second controller decreases the frequency of the pulse signal in a case where the voltage output from the power supply device is smaller than a second voltage, and the second controller increases the frequency of the pulse signal in a case where the voltage output from the power supply device is greater than the second voltage and the determined frequency is smaller than a predetermined frequency, in the second power mode, the second voltage being smaller than the first voltage, wherein the second controller stops output of the pulse signal in a case where the voltage output from the power supply device is greater than the second voltage and the determined frequency is greater than the predetermined frequency, in the second power mode, and wherein the second controller starts the output of the pulse signal in a case where the voltage output from the power supply device decreases due to stoppage of the output of the pulse signal and reaches the second voltage, in the second power mode.

Further features of the present disclosure will become apparent from the following description of example embodiments with reference to the attached drawings.

### BRIEF DESCRIPTION OF THE DRAWINGS

FIG. 1 is a cross-sectional diagram illustrating an image forming apparatus according to an example embodiment.

FIG. 2 is a block diagram illustrating a control configuration of the image forming apparatus.

FIG. 3 is a diagram illustrating a configuration of a power supply device.

FIG. 4 is a diagram illustrating an electric current flowing through a primary winding wire of a transformer and an electric current flowing through a secondary winding wire of the transformer.

FIG. 5 is a diagram illustrating a relationship between an output voltage and a drive frequency, for each magnitude of a load.

FIG. 6 is a diagram illustrating an output path of a voltage output from the power supply device.

FIG. 7 is a diagram illustrating a relationship between the output voltage and the drive frequency in a power saving mode.

### DESCRIPTION OF THE EMBODIMENTS

Example embodiments of the present disclosure will be described below with reference to the drawings. The shapes and relative arrangements of components described in the example embodiments are to be modified as appropriate based on the configuration and various conditions of an apparatus to which the present invention is applied, and the scope of the present invention is not intended to be limited to the following example embodiments.

### [Image Forming Apparatus]

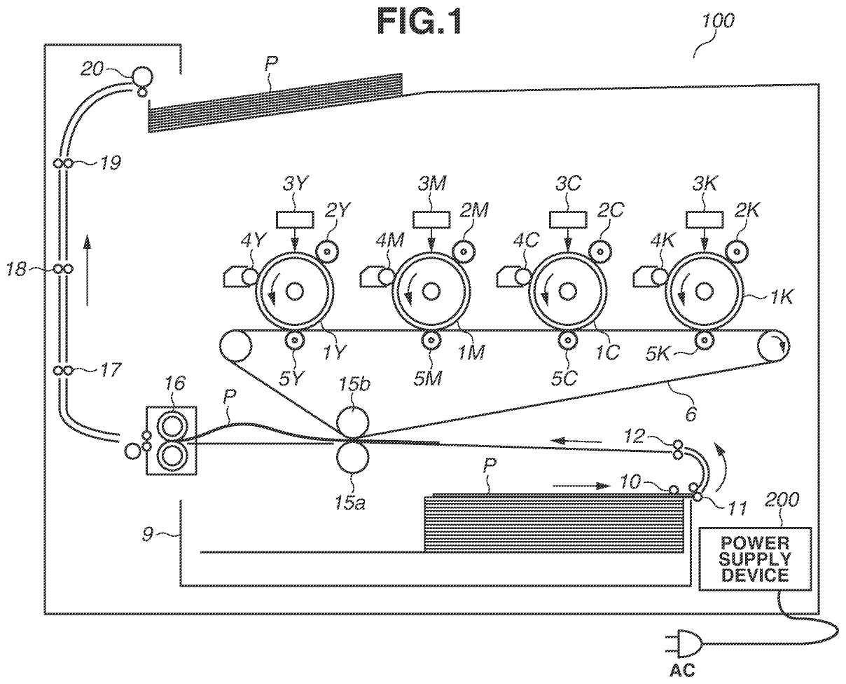

FIG. 1 is a cross-sectional diagram illustrating a configuration of an electrophotographic color copier (hereinafter referred to as an image forming apparatus) 100 having a sheet conveyance device and used in a first example embodiment. The image forming apparatus 100 is not limited to the copier, and may be, for example, a facsimile, a printing press, or a printer. The recording method thereof is not limited to the electrophotographic method and may be, for example, an ink-jet method. The image forming apparatus 100 may be of either a monochrome type or a color type.

A configuration and a function of the image forming apparatus 100 will be described below with reference to FIG. 1.

A sheet storage tray 9 that stores recording media P is disposed inside the image forming apparatus 100. The recording medium is a medium on which an image is to be formed by an image forming apparatus, and examples of the recording medium include a paper sheet, a resin sheet, a cloth, an overhead projector (OHP) sheet, and a label.

The recording media P stored in the sheet storage tray 9 are each sent out by a pickup roller 10 and then conveyed to a registration roller 12 by a conveyance roller 11.

An image signal output from an external apparatus such as a personal computer (PC) is input to optical scanning devices 3Y, 3M, 3C, and 3K so that different color components of the image signal are input to respective optical scanning devices 3Y, 3M, 3C, and 3K. Each of the optical scanning devices 3Y, 3M, 3C, and 3K includes a semiconductor laser and a polygon mirror. Specifically, an image signal for yellow output from the external apparatus is input to the optical scanning device 3Y, and an image signal for magenta output from the external apparatus is input to the optical scanning device 3M. Further, an image signal for cyan output from the external apparatus is input to the optical scanning device 3C, and an image signal for black output from the external apparatus is input to the optical scanning device 3K. Although a configuration for forming an image of yellow will be described below, a similar configuration is provided for each of magenta, cyan, and black.

An outer peripheral surface of a photosensitive drum 1Y is charged by a charger 2Y. After being charged, the outer peripheral surface of the photosensitive drum 1Y is irradiated with a laser beam emitted from the optical scanning device 3Y and corresponding to the image signal input from the external apparatus to the optical scanning device 3Y, via an optical system such as the polygon mirror. As a result, an electrostatic latent image is formed on the outer peripheral surface of the photosensitive drum 1Y.

Subsequently, the electrostatic latent image is developed with toner of a development device 4Y, so that a toner image is formed on the outer peripheral surface of the photosensitive drum 1Y. The toner image formed on the photosensitive drum 1Y is transferred to a transfer belt 6 by a transfer roller 5Y disposed at a position opposing the photosensitive drum 1Y.

The yellow, magenta, cyan, and black toner images transferred to the transfer belt 6 are transferred to a recording medium P by a pair of transfer rollers 15a and 15b. The registration roller 12 sends the recording medium P to the pair of transfer rollers 15a and 15b serving as a transfer unit so that the recording medium P timely arrives at the transfer rollers 15a and 15b for the transfer.

The recording medium P to which the toner images are thus transferred is sent to a fixing unit 16, and heated and pressed by the fixing unit 16, so that the toner images are fixed to the recording medium P. The image forming apparatus 100 forms an image on the recording medium P in this manner. The recording medium P on which the image is formed is discharged to the outside of the image forming apparatus 100 by conveyance rollers 17, 18, 19, and 20.

The description of the configuration and the function of the image forming apparatus 100 has been provided as the above.

### <Control Configuration of Image Forming Apparatus>

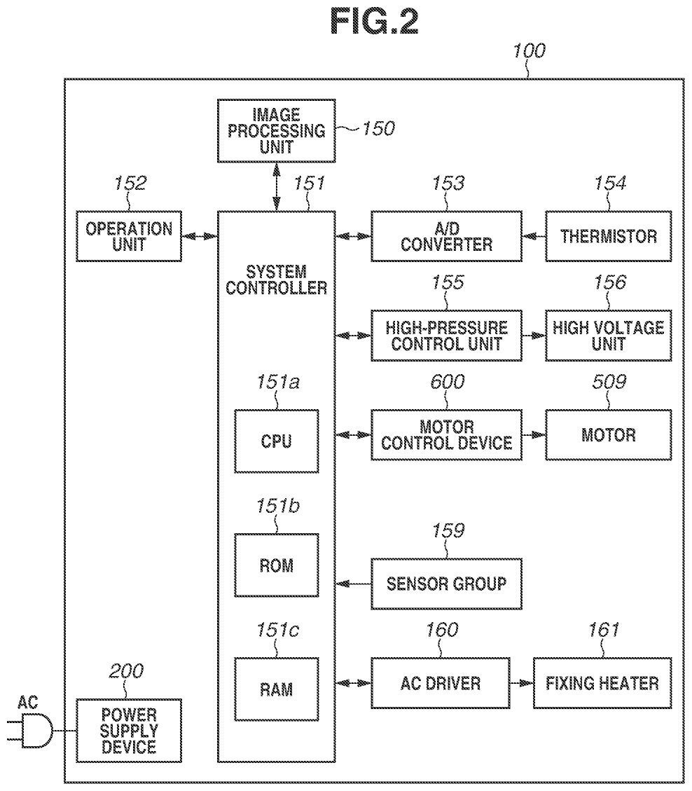

FIG. 2 is a block diagram illustrating an example of a control configuration of the image forming apparatus 100. The image forming apparatus 100 includes a power supply device 200 as illustrated in FIG. 2. The power supply device 200 is connected to an alternate current (AC) power source (commercial power source) AC, and various devices in the image forming apparatus 100 operate on power output from the power supply device 200.

A system controller 151 includes a central processing unit (CPU) 151a, a read only memory (ROM) 151b, and a random access memory (RAM) 151c as illustrated in FIG. 2. The system controller 151 is connected with an image processing unit 150, an operation unit 152, an analog-digital (A/D) converter 153, a high-pressure control unit 155, a motor control device 600, a sensor group 159, and an AC driver 160. The system controller 151 can transmit and receive data and commands to and from each of the connected units.

The CPU 151a reads various programs stored in the ROM 151b and executes the programs, thereby performing various sequences related to a predetermined image formation sequence.

The RAM 151c is a storage device. The RAM 151c stores various types of data including a setting value for a high voltage unit 156, a command value for the motor control device 600, and information received from the operation unit 152.

The system controller 151 transmits setting value data of various devices disposed inside the image forming apparatus 100 to the image processing unit 150, for image processing in the image processing unit 150. Further, the system controller 151 receives a signal from the sensor group 159, and controls the high voltage unit 156 based on the received signal.

The high-pressure control unit 155 drives the high voltage unit 156 (the chargers 2Y, 2M, 2C, and 2K, the development devices 4Y, 4M, 4C, and 4K, and the pair of transfer rollers 15a and 15b) based on a control signal output from the system controller 151.

The motor control device 600 drives a motor 509 that drives a load in the image forming apparatus 100 based on a command output from the CPU 151a.

The A/D converter 153 receives a detection signal detected by a thermistor 154 for detecting the temperature of a fixing heater 161, converts the detection signal from an analog signal into a digital signal, and transmits the digital signal to the system controller 151. The system controller 151 controls the AC driver 160 based on the digital signal received from the A/D converter 153. The AC driver 160 controls the fixing heater 161 so that the temperature of the fixing heater 161 becomes a temperature desirable for fixing. The fixing heater 161 is a heater used for fixing and included in the fixing unit 16.

The system controller 151 controls the operation unit 152 to display an operation screen for a user to set information such as a recording medium type (paper type) to be used, on a display portion of the operation unit 152. The system controller 151 receives the information set by the user from the operation unit 152, and controls an operation sequence of the image forming apparatus 100 based on the information set by the user. Further, the system controller 151 transmits information indicating the state of the image forming apparatus 100 to the operation unit 152. Examples of the information indicating the state of the image forming apparatus 100 include the number of sheets subjected to image formation, the progress of image forming operation, and information about a paper jam, double feeding of sheets, or the like in an image printer or a document feeder. The operation unit 152 displays the information received from the system controller 151 on the display portion.

The system controller 151 controls the operation sequence of the image forming apparatus 100 in the above-described manner.

### <Power Mode>

The image forming apparatus 100 according to the present example embodiment has a normal power mode in which an image can be formed on a recording medium, and a power saving mode (sleep mode) in which the number of loads to be supplied with power is less than that in the normal power mode and power consumption is smaller than that in the normal power mode. For example, the CPU 151a performs switching between the normal power mode and the power saving mode in response to a press of a power switch in the operation unit 152 by a user. In other words, the CPU 151a functions as a first controller.

In the normal power mode, the power is supplied from the power supply device 200 to the operation unit 152, the CPU 151a, the high-pressure control unit 155, the high voltage unit 156, the motor control device 600, the motor 509, the sensor group 159, the AC driver 160, and the like. As a result, an image can be formed on the recording medium p.

On the other hand, in the power saving mode, the power is supplied from the power supply device 200 to the operation unit 152 and the CPU 151a, and no power is supplied to the high-pressure control unit 155, the high voltage unit 156, the motor control device 600, the motor 509, and the AC driver 160. As a result, the power consumption is smaller than that in the normal power mode.

### [Power Supply Device]

### <Configuration and Operation of Power Supply Device>

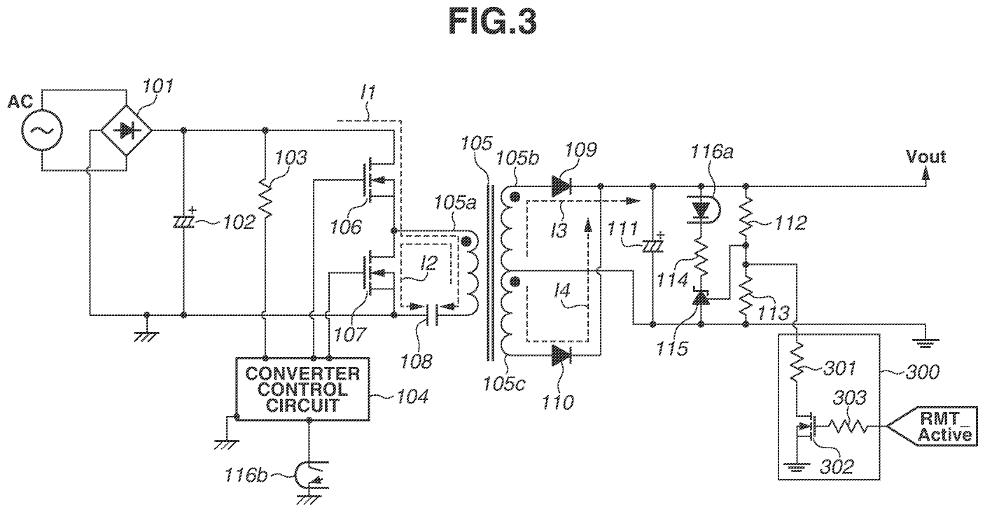

FIG. 3 is a diagram illustrating a configuration of the power supply device 200. The power supply device 200 is an alternate current/direct current (AC/DC) power source that converts an alternate-current voltage supplied from a commercial power source into a direct-current voltage by a current resonance method, and outputs the direct-current voltage.

The power supply device 200 includes a circuit on the primary side to which a commercial power source AC is connected, and a circuit on the secondary side insulated from the circuit on the primary side.

The commercial power source AC is connected to a diode bridge 101, and a direct-current output terminal of the diode bridge 101 is connected to a smoothing capacitor 102. In a stage subsequent to the smoothing capacitor 102, a half bridge composed of a first switching element 106 and a second switching element 107 is connected to the smoothing capacitor 102 in parallel. A resonance circuit in which a primary winding wire 105a of a transformer 105 and a resonance capacitor 108 are connected in parallel is connected to the second switching element 107 in parallel. The resonance circuit composed of the primary winding wire 105a of the transformer 105 and the resonance capacitor 108 may be connected to the first switching element 106 in parallel.

The transformer 105 is used to transmit power on the primary side to the secondary side while maintaining the insulation state between the circuit of the primary side and the circuit of the secondary side. Thus, the primary winding wire 105a and secondary winding wires 105b and 105c of the transformer 105 are wound around the same core. The inductance of the primary winding wire 105a of the transformer 105 includes a component connected to the secondary winding wires 105b and 105c, and a component (leakage inductance) not connected to the secondary winding wires 105b and 105c.

One end of the secondary winding wire 105b of the transformer 105 is connected to the ground on the secondary side, and the other end is connected to an anode of a rectifier diode 109. Further, one end of the secondary winding wire 105c of the transformer 105 is connected to the ground on the secondary side, and the other end is connected to an anode of a rectifier diode 110.

A cathode of the rectifier diode 109 and a cathode of the rectifier diode 110 are connected to each other to have the same potential, and connected to one end of a smoothing capacitor 111. The other end of the smoothing capacitor 111 is connected to the ground.

The alternate-current voltage input to the power supply device 200 is rectified by the diode bridge 101, and subsequently smoothed by the smoothing capacitor 102. The direct-current voltage obtained by the smoothing is applied to a converter control circuit 104 via a starting resistance 103. As a result, the power is supplied to the converter control circuit 104. The diode bridge 101 functions as a rectification unit.

The converter control circuit 104 includes a voltage control oscillator (VOC) that generates a pulse signal (a pulse width modulation signal) for driving the first switching element 106 and the second switching element 107. The first switching element 106 and the second switching element 107 are driven by the pulse signal output from the VOC. The converter control circuit 104 drives the first switching element 106 and the second switching element 107 alternately at a duty ratio of 50%. In other words, the converter control circuit 104 drives the first switching element 106 and the second switching element 107 so that the second switching element 107 is off in a case where the first switching element 106 is on, and the second switching element 107 is on in a case where the first switching element 106 is off. As a result, a square wave is applied to the resonance circuit composed of the primary winding wire 105a of the transformer 105 and the resonance capacitor 108, so that an alternating current flows through the primary winding wire 105a of the transformer 105. The pulse signal is a signal in which a signal at a high level (first level) and a signal at a low level (second level) are periodically repeated.

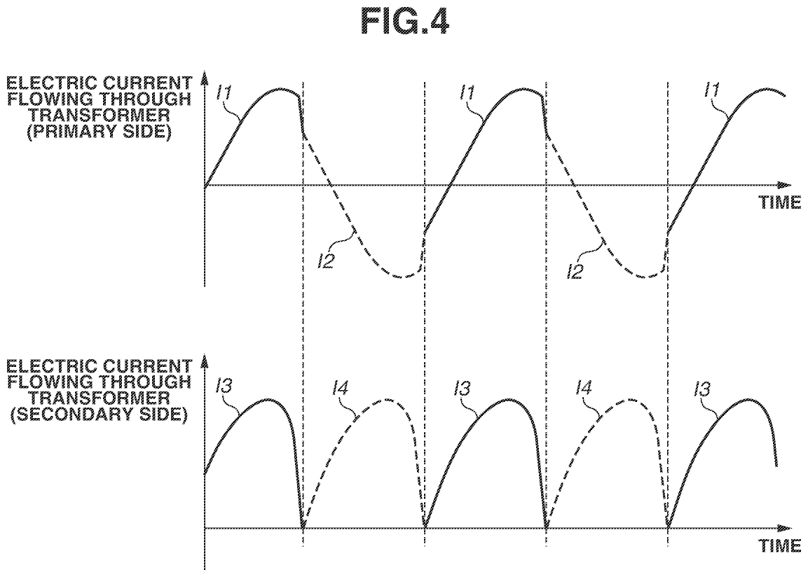

FIG. 4 is a diagram illustrating an electric current flowing through the primary winding wire 105a of the transformer 105, and an electric current flowing through the secondary winding wire 105b or 105c of the transformer 105. The primary winding wire 105a functions as a first winding wire, and at least one of the secondary winding wires 105b and 105c functions as a second winding wire.

When the first switching element 106 is in the on state and the second switching element 107 is in the off state, an electric current I1 from the smoothing capacitor 102 flows in order of the first switching element 106, the primary winding wire 105a of the transformer 105, and the resonance capacitor 108. At this moment, on the secondary side, an electric current I3 flows from the secondary winding wire 105b to the rectifier diode 109 and then to the smoothing capacitor 111.

On the other hand, when the first switching element 106 is in the off state and the second switching element 107 is in the on state, an electric current I2 from the resonance capacitor 108 flows in order of the primary winding wire 105a of the transformer 105 and the second switching element 107. At this moment, on the secondary side, an electric current I4 flows from the secondary winding wire 105c to the rectifier diode 110 and then to the smoothing capacitor 111.

In this way, the first switching element 106 and the second switching element 107 are driven, so that the alternating current flows through the primary winding wire 105a of the transformer 105, and a magnetic flux generated by the alternating current passes through the secondary winding wire 105b or 105c via the core of the transformer 105. An alternate-current voltage is induced in the secondary winding wire 105b or 105c due to the magnetic flux passing through the secondary winding wire 105b or 105c, and an alternating current flows through the secondary winding wire 105b or 105c due to the induced alternate-current voltage. After being rectified by the rectifier diode 109 or 110, the alternating current flowing through the secondary winding wire 105b or 105c is smoothed by the smoothing capacitor 111. As a result, a direct-current voltage is obtained in the circuit on the secondary side. A voltage across the smoothing capacitor 111 is an output voltage Vout of the power supply device 200.

### <Control of Output Voltage Vout>

### {Feedback of Output Voltage Vout}

The output voltage Vout is input to a photocoupler light emitting unit 116a. Further, the output voltage Vout is divided by resistances 112 and 113, and input to a shunt regulator 115.

In a case where the input voltage is higher than a reference voltage, the shunt regulator 115 increases the electric current flowing through the photocoupler light emitting unit 116a. In a case where the input voltage is lower than the reference voltage, the shunt regulator 115 decreases the electric current flowing through the photocoupler light emitting unit 116a. When the electric current flows through the photocoupler light emitting unit 116a, the photocoupler light emitting unit 116a emits light. The light emitted from the photocoupler light emitting unit 116a is incident on a photocoupler light receiving unit 116b. An electric current corresponding to the amount of the received light flows through the photocoupler light receiving unit 116b. In other words, the photocoupler light emitting unit 116a on the secondary side transmits information about the output voltage Vout to the circuit on the primary side while maintaining the insulation state with respect to the circuit on the primary side.

The output voltage Vout changes depending on the frequency (drive frequency) of the pulse signal. Specifically, the output voltage Vout is expressed by the following formula (1).

$$Vout = \frac{Vin \times M}{2 N} \qquad ( 1 )$$

In the formula, N represents the ratio (N=N1/N2) of the number N1 of windings of the primary winding wire 105a to the number N2 of windings of the secondary winding wire 105b (or the secondary winding wire 105c), Vin represents a voltage across the smoothing capacitor 102, and M represents a resonance circuit gain. The resonance circuit gain M is a function in which the drive frequency and the load are variables. In other words, the output voltage Vout is a function of the drive frequency and the load.

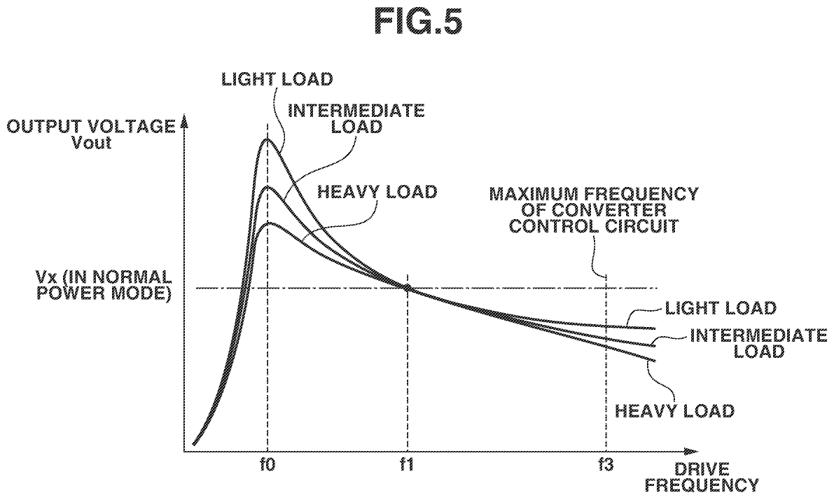

FIG. 5 is a diagram illustrating a relationship between the output voltage Vout and the drive frequency, for each magnitude of the load. A frequency f3 in FIG. 5 is the maximum of a frequency that can be output by the converter control circuit 104. The frequency f3 is determined based on an internal circuit constant of the VOC included in the converter control circuit 104. In other words, the frequency f3 is determined by specifications of the converter control circuit 104. The converter control circuit 104 may include a setting unit for setting the maximum (less than f3) of the frequency that can be output.

A frequency f0 in FIG. 5 is a resonance frequency of the circuit on the primary side in a state where the secondary winding wire 105b or 105c is open, and the frequency f0 is expressed by the following formula (2).

$$f 0 = \frac{1}{2 π \sqrt{L \times C}} \qquad ( 2 )$$

In the formula, L represents the inductance of the primary winding wire 105a in the state where the secondary winding wire 105b or 105c is open, and C represents the electric capacity of the resonance capacitor 108. An area where the drive frequency is lower than f0 is called a capacitance area and current resonance cannot be performed in the area. In other words, the converter control circuit 104 controls the drive frequency in the range of f0 to f3.

The converter control circuit 104 controls the drive frequency for switching the first switching element 106 and the second switching element 107, based on the electric current flowing through the photocoupler light receiving unit 116b. In other words, the converter control circuit 104 controls the drive frequency for switching the first switching element 106 and the second switching element 107, based on the electric current flowing through the photocoupler light receiving unit 116b to make the output voltage Vout become a voltage corresponding to the reference voltage of the shunt regulator 115. Specifically, the converter control circuit 104 lowers the drive frequency in a case where the electric current flowing through the photocoupler light receiving unit 116b indicates that the output voltage Vout is smaller than the voltage corresponding to the reference voltage. Meanwhile, the converter control circuit 104 raises the drive frequency in a case where the electric current flowing through the photocoupler light receiving unit 116b indicates that the output voltage Vout is greater than the voltage corresponding to the reference voltage. In other words, the converter control circuit 104 decreases the frequency of the pulse signal in a case where the voltage output from the power supply device 200 is smaller than the reference voltage, and increases the frequency of the pulse signal in a case where the voltage output from the power supply device 200 is greater than the reference voltage. In this way, the converter control circuit 104 determines the frequency of the pulse signal for switching between the on state and the off state of the switching element, and outputs the pulse signal of the determined frequency. The converter control circuit 104 functions as a second controller. The converter control circuit 104 performs a comparison between the output voltage Vout and the reference voltage at predetermined time intervals. Then, the converter control circuit 104 reduces the drive frequency by a predetermined value in the case of lowering the drive frequency, and increases the drive frequency by a predetermined value in the case of raising the drive frequency. In other words, the converter control circuit 104 determines the drive frequency at predetermined time intervals.

### {Switching of Reference Voltage}

As illustrated in FIG. 3, the power supply device 200 according to the present example embodiment includes an output voltage switching circuit 300 that switches the magnitude of the output voltage Vout (the magnitude of the reference voltage). The output voltage switching circuit 300 includes a resistance 301 and a switching element 302. One end of the resistance 301 is connected to a point between the resistances 112 and 113, and the other end is connected to one end of the switching element 302. The other end of the switching element 302 is connected to the ground.

The switching element 302 is switched between on and off by a signal RMT_Active output from the CPU 151a. In a case where the switching element 302 is switched to the on state by the signal RMT_Active, the resistance 113 and the resistance 301 are connected in parallel. On the other hand, in a case where the switching element 302 is in the off state, the resistance 301 is separated from the resistance 113. A combined resistance of the resistance 113 and the resistance 301 is smaller when the switching element 302 is in the on state than when the switching element 302 is in the off state. In other words, the reference voltage of the shunt regulator 115 is greater when the switching element 302 is in the on state than when the switching element 302 is in the off state. In other words, the target voltage of the output voltage Vout is greater when the switching element 302 is in the on state than when the switching element 302 is in the off state.

### {Target Voltage in Normal Power Mode}

As illustrated in FIG. 5, a curve of the output voltage Vout at a light load when the load on the secondary side is relatively small, a curve of the output voltage Vout at a load when the load on the secondary side is intermediate, and a curve of the output voltage Vout at a heavy load when the load on the secondary side is relatively large cross each other at one point where the output voltage Vout is Vx (where the drive frequency is f1). This means that the output voltage Vout is constant in a state where the drive frequency is f1, regardless of whether the magnitude of the load on the secondary side has changed. The frequency f1 is a resonance frequency of the circuit on the primary side in a state where the secondary winding wire 105b or 105c is shorted, and the frequency f1 is expressed by the following formula (3).

$$f 1 = \frac{1}{2 π \sqrt{Llk \times C}} \qquad ( 3 )$$

In the formula, Llk represents an inductance (leakage inductance) corresponding to a leakage flux of the primary winding wire 105a in a state where the secondary winding wire 105b or 105c is shorted.

In the present example embodiment, components such as the transformer 105 are adjusted so that a voltage Vx (e.g., 24 V) when the drive frequency is f1 is output as the output voltage Vout in the normal power mode. In other words, in the present example embodiment, various components of the circuit are adjusted so that a voltage at which the curve of the output voltage Vout at the light load, the curve of the output voltage Vout at the intermediate load, and the curve of the output voltage Vout at the heavy load cross each other at one point is output from the power supply device 200 in the normal power mode. As a result, in the normal power mode, the power supply device 200 can output a constant voltage even if the load on the secondary side fluctuates in a situation where a load fluctuation easily occurs, e.g., during image formation. In other words, the operation of the image forming apparatus 100 can be stabilized.

In addition, in the present example embodiment, the CPU 151a changes the switching element 302 to the on state based on the signal RMT_Active in a case where the image forming apparatus 100 is the normal power mode. In other words, in the present example embodiment, the converter control circuit 104 controls the drive frequency based on the reference voltage in the state where the switching element 302 is turned on based on the signal RMT_Active, so that the voltage Vx is output as the output voltage Vout.

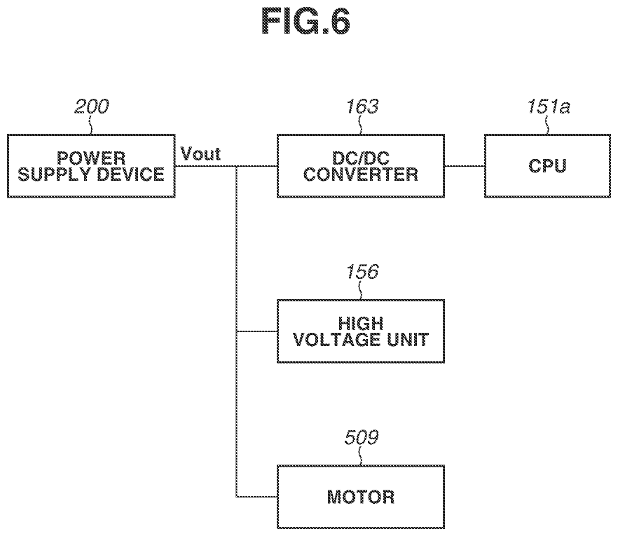

The high-pressure control unit 155, the high voltage unit 156, the motor control device 600, and the motor 509 can operate at the voltage Vx, and do not operate at a voltage Ve to be described below. On the other hand, the operation unit 152 and the CPU 151a operate at the voltage Ve. In other words, in the present example embodiment, for example, as illustrated in FIG. 6, after the output voltage Vout output from the power supply device 200 is lowered to the voltage Ve by a known DC/DC converter (conversion unit), the voltage Ve is input to the operation unit 152 and the CPU 151a, in the normal power mode. On the other hand, in the power saving mode, the voltage Ve is input to the operation unit 152 and the CPU 151a without lowering of the output voltage Vout output from the power supply device 200 by the DC/DC converter. FIG. 6 illustrates an example in which the voltage Vout lowered to the voltage Ve by a DC/DC converter 163 serving as the conversion unit is input to the CPU 151a. However, the voltage Vout lowered to the voltage Ve by the DC/DC converter 163 is also input to, for example, the operation unit 152. Further, in the example in FIG. 6, the voltage Vout output from the power supply device 200 is input to the high voltage unit 156 and the motor 509. However, the voltage Vout output from the power supply device 200 is also input to, for example, the high-pressure control unit 155 and the motor control device 600. There may be adopted a configuration in which the high voltage unit 156, the motor 509, the high-pressure control unit 155, the motor control device 600, and the like are not supplied with the voltage (power) from the power supply device 200 in the power saving mode.

The target voltage of the output voltage Vout in the normal power mode may differ from the voltage Vx by a predetermined value (e.g., about ±5%). The target voltage (i.e., the voltage Vx) of the output voltage Vout in the normal power mode is set to a value based on which the power to be consumed in the normal power mode can be supplied.

### {Target Voltage in Power Saving Mode}

There will be described below a method of controlling the output voltage Vout in the light load state where the magnitude of the load on the secondary side is relatively small, i.e., when the image forming apparatus 100 is in the power saving mode. In the present example embodiment, the following configuration is used to prevent a decrease in the efficiency in the image forming apparatus 100 while preventing increases in the size and the cost of the image forming apparatus 100.

As described above, in the present example embodiment, the power consumption in the power saving mode is smaller than the power consumption in the normal power mode. In other words, in the power saving mode, the image forming apparatus 100 can operate at an output voltage Vout smaller than the output voltage Vout in the normal power mode. Thus, in the present example embodiment, the CPU 151a changes the switching element 302 from the on state to the off state when the power mode of the image forming apparatus 100 is switched from the normal power mode to the power saving mode. As a result, the reference voltage of the shunt regulator 115 decreases, and the target voltage of the output voltage Vout decreases from Vx (e.g., 24 V) to Ve (e.g., 5 V).

When the reference voltage of the shunt regulator 115 decreases from the voltage corresponding to Vx to the voltage corresponding to Ve, the converter control circuit 104 decreases the drive frequency of the pulse signal for driving the first switching element 106 and the second switching element 107 to decrease the output voltage Vout. As a result, the magnitude of the electric current flowing through the primary winding wire 105a of the transformer 105 decreases, and the output voltage Vout generated on the secondary side decreases.

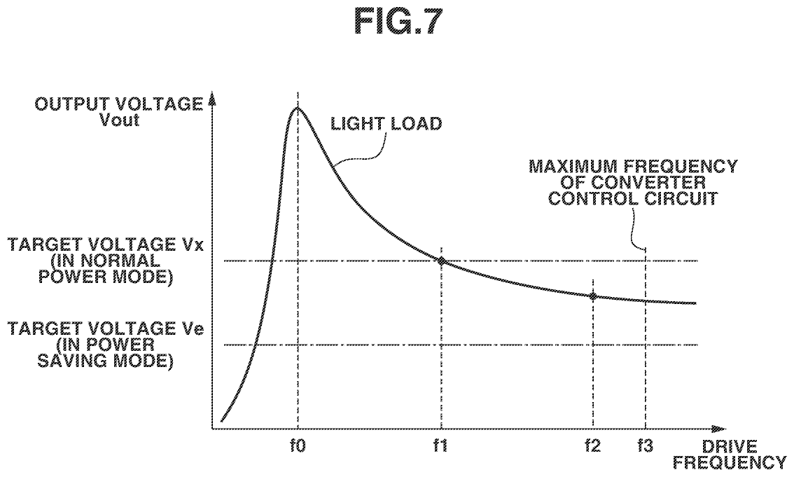

FIG. 7 is a diagram illustrating a relationship between the output voltage Vout and the drive frequency at the time of the light load in FIG. 5, i.e., in the power saving mode. As illustrated in FIG. 7, in the present example embodiment, the drive frequency is to be greater than f3 to output the target voltage Ve in the power saving mode. However, as described above, the frequency f3 is the maximum of the frequency that can be output by the converter control circuit 104.

In the present example embodiment, the converter control circuit 104 increases the drive frequency in a case where the determined frequency of the pulse signal is smaller than f3 in a state where the output voltage Vout smaller than the target voltage Ve is detected based on the electric current flowing through the photocoupler light receiving unit 116b. Then, the converter control circuit 104 stops the output of the pulse signal in a case where the determined frequency of the pulse signal is greater than f3 in the state where the output voltage Vout smaller than the target voltage Ve is detected based on the electric current flowing through the photocoupler light receiving unit 116b. As a result, the output voltage Vout generated on the secondary side becomes smaller than the output voltage Vout corresponding to the frequency f3. The frequency f3 corresponds to a predetermined frequency.

Then, when detecting the output voltage Vout smaller than the target voltage Ve based on the electric current flowing through the photocoupler light receiving unit 116b, the converter control circuit 104 starts the output of the pulse signal for driving the first switching element 106 and the second switching element 107. In other words, the converter control circuit 104 starts the output of the pulse signal when the output voltage Vout decreasing due to the stoppage of the output of the pulse signal reaches the target voltage Ve. For example, the converter control circuit 104 first outputs the pulse signal corresponding to the frequency f3 when starting the output of the pulse signal, but the pulse signal is not limited to this example. For example, the converter control circuit 104 may first output the pulse signal corresponding to a frequency smaller than f3 when starting the output of the pulse signal.

The power consumption of the operating load (such as the operation unit 152 or the CPU 151a) is relatively small compared to the power consumption of the high-pressure control unit 155, the high voltage unit 156, the motor control device 600, and the motor 509, and thus, a load fluctuation is less likely to occur in the power saving mode. Therefore, the power can be supplied to the secondary side in a relatively stable manner even if the drive frequency is not f1.

As described above, in the present example embodiment, the first switching element 106 and the second switching element 107 are driven so that the output voltage Vout of the power supply device 200 in the power saving mode becomes smaller than the output voltage Vout of the power supply device 200 in the normal power mode. Specifically, the converter control circuit 104 stops the output of the pulse signal to decrease the output voltage Vout to the target voltage Ve in the power saving mode. Then, the converter control circuit 104 starts the output of the pulse signal when the output voltage Vout becomes smaller than the target voltage Ve, and the converter control circuit 104 stops the output of the pulse signal when the output voltage Vout becomes greater than the target voltage Ve. In other words, in the present example embodiment, the converter control circuit 104 repeats the output and the stoppage of the pulse signal in the power saving mode. The magnitude of the exciting current flowing through the primary winding wire in the power saving mode can be made smaller than the magnitude of the exciting current flowing through the primary winding wire in the normal power mode by decreasing the output voltage Vout in the power saving mode. In other words, it is possible to prevent the efficiency of the power supply device 200 in the power saving mode from becoming lower than the efficiency of the power supply device 200 in the normal power mode. In addition, it is possible to prevent increases in the size and the cost of the power supply device 200 that can occur due to reasons such as disposing two types of winding wire in the circuit on the primary side as a winding wire of a relay circuit or a transformer, or disposing a control unit for controlling the relay circuit on the secondary side. In other words, the present example embodiment can prevent a decrease in efficiency in an apparatus while preventing increases in the size and the cost of the apparatus.

In a second example embodiment, a description of a part similar to that in the configuration of the image forming apparatus 100 according to the first example embodiment will be omitted.

In the second example embodiment, when the power mode of the image forming apparatus 100 is switched from the normal power mode to the power saving mode, the CPU 151a changes the switching element 302 from the on state to the off state. Further, the CPU 151a notifies the converter control circuit 104 that the power mode has been switched from the normal power mode to the power saving mode. Specifically, when the power mode is switched from the normal power mode to the power saving mode, the CPU 151a notifies the converter control circuit 104 that the power mode has been switched from the normal power mode to the power saving mode while maintaining the insulation state with respect to the circuit on the primary side by using a photocoupler or the like.

Upon being notified by the CPU 151a that the power mode has been switched from the normal power mode to the power saving mode, the converter control circuit 104 stops the output of the pulse signal to the first switching element 106 and the second switching element 107. In other words, when being notified by the CPU 151a that the power mode has been switched from the normal power mode to the power saving mode, the converter control circuit 104 stops the output of the pulse signal that has been output at the frequency f1.

Then, when detecting the output voltage Vout smaller than the target voltage Ve based on the electric current flowing through the photocoupler light receiving unit 116b, the converter control circuit 104 starts the output of the pulse signal to drive the first switching element 106 and the second switching element 107. For example, the converter control circuit 104 first outputs the pulse signal corresponding to the frequency f3 when starting the output of the pulse signal, but the pulse signal is not limited to this example. For example, the converter control circuit 104 may first output the pulse signal corresponding to a frequency greater than f3 when starting the output of the pulse signal.

As described above, in the present example embodiment, the first switching element 106 and the second switching element 107 are driven so that the output voltage Vout of the power supply device 200 in the power saving mode becomes smaller than the output voltage Vout of the power supply device 200 in the normal power mode. The magnitude of the exciting current flowing through the primary winding wire in the power saving mode can be made smaller than the magnitude of the exciting current flowing through the primary winding wire in the normal power mode by decreasing the output voltage Vout in the power saving mode. In other words, it is possible to prevent the efficiency of the power supply device 200 in the power saving mode from becoming lower than the efficiency of the power supply device 200 in the normal power mode. In addition, it is possible to prevent increases in the size and the cost of the power supply device 200 that can occur due to reasons such as disposing two types of winding wire in the circuit on the primary side as a winding wire of a relay circuit or a transformer, or disposing a control unit for controlling the relay circuit on the secondary side. In other words, the present example embodiment can prevent a decrease in efficiency in an apparatus while preventing increases in the size and the cost of the apparatus.

The chargers 2Y, 2M, 2C, and 2K, the development devices 4Y, 4M, 4C, and 4K, the transfer rollers 5Y, 5M, 5C, and 5K, and the pair of transfer rollers 15a and 15b are included in an image forming unit.

In various example embodiments of the present disclosure, it is possible to prevent a decrease in efficiency in an apparatus while preventing increases in the size and the cost of the apparatus.

While example embodiments have been described, it is to be understood that the disclosure is not limited to the disclosed example embodiments. The scope of the following claims is to be accorded the broadest interpretation so as to encompass all such modifications and equivalent structures and functions.

This application claims the benefit of Japanese Patent Application No. 2021-023542, filed Feb. 17, 2021, which is hereby incorporated by reference herein in its entirety.

What is claimed is:

1. An image forming apparatus comprising:
an image forming unit configured to form an image on a recording medium;
a first controller configured to switch between a first power mode in which image formation by the image forming unit is enabled and a second power mode in which a number of loads supplied with power is less than a number of loads in the first power mode and power consumption is less than power consumption in the first power mode; and
a power supply device configured to convert an alternate-current voltage output from a commercial power source into a direct-current voltage, the power supply device including:
a rectification unit configured to rectify the alternate-current voltage output from the commercial power source;
a smoothing capacitor configured to smooth the voltage rectified by the rectification unit;
a transformer including a first winding wire to which the voltage smoothed by the smoothing capacitor is applied and a second winding wire insulated from the first winding wire;
a capacitor connected to the first winding wire in series;
a switching element connected to both the first winding wire and the capacitor in parallel; and
a second controller configured to determine a frequency of a pulse signal for switching between an on state and an off state of the switching element and to output the pulse signal of the determined frequency, the pulse signal being a signal in which a signal at a first level and a signal at a second level are repeated,
wherein the power supply device outputs a voltage based on a voltage generated in the second winding wire due to the voltage applied to the first winding wire,
wherein the second controller decreases the frequency of the pulse signal in a case where the voltage output from the power supply device is smaller than a first voltage, and the second controller increases the frequency of the pulse signal in a case where the voltage output from the power supply device is greater than the first voltage, in the first power mode,
wherein the second controller decreases the frequency of the pulse signal in a case where the voltage output from the power supply device is smaller than a second voltage, and the second controller increases the frequency of the pulse signal in a case where the voltage output from the power supply device is greater than the second voltage and the determined frequency is smaller than a predetermined frequency, in the second power mode, the second voltage being smaller than the first voltage,
wherein the second controller stops output of the pulse signal in a case where the voltage output from the power supply device is greater than the second voltage and the determined frequency is greater than the predetermined frequency, in the second power mode, and
wherein the second controller starts the output of the pulse signal in a case where the voltage output from the power supply device decreases due to stoppage of the output of the pulse signal and reaches the second voltage, in the second power mode.

2. The image forming apparatus according to claim 1, further comprising a conversion unit configured to lower the voltage output from the power supply device,
wherein the first controller operates at the voltage lowered by the conversion unit in the first power mode, and
wherein the first controller operates at the voltage output from the power supply device in the second power mode.

3. The image forming apparatus according to claim 2, wherein the voltage output from the power supply device is supplied to the first controller without being lowered by the conversion unit in the second power mode.

4. The image forming apparatus according to claim 1,
wherein the image forming unit includes a transfer unit configured to transfer an image to the recording medium, and
wherein the transfer unit transfers the image to the recording medium based on the voltage output from the power supply device in the first power mode.

5. The image forming apparatus according to claim 1, wherein the power is not supplied from the power supply device to the image forming unit in the second power mode.

6. The image forming apparatus according to claim 1, wherein the second controller starts the output of the pulse signal having a frequency less than or equal to the predetermined frequency in the case where the voltage output from the power supply device decreases due to the stoppage of the output of the pulse signal and reaches the second voltage, in the second power mode.

7. The image forming apparatus according to claim 6, wherein the second controller starts the output of the pulse signal having the predetermined frequency in the case where the voltage output from the power supply device decreases due to the stoppage of the output of the pulse signal and reaches the second voltage, in the second power mode.

8. The image forming apparatus according to claim 1,
wherein the switching element is a first switching element, and the power supply device further includes a second switching element connected to a resonance circuit in series and the first switching element in series, the resonance circuit including the first winding wire and the capacitor,
wherein the pulse signal is a first pulse signal, and the second controller determines a frequency of a second pulse signal for switching between an on state and an off state of the second switching element, and outputs the second pulse signal of the determined frequency, the second pulse signal being a signal in which a signal at a third level and a signal at a fourth level are periodically repeated,
wherein the second controller decreases the frequency of the second pulse signal in a case where the frequency of the first pulse signal is decreased, and the second controller increases the frequency of the second pulse signal in a case where the frequency of the first pulse signal is increased, and
wherein the second controller stops output of the second pulse signal in a case where the output of the first pulse signal is stopped.

9. The image forming apparatus according to claim 1,
wherein the smoothing capacitor is a first smoothing capacitor,
wherein the power supply device further includes:
a second smoothing capacitor configured to smooth the voltage generated in the second winding wire due to the voltage applied to the first winding wire; and
a detection unit configured to detect the voltage smoothed by the second smoothing capacitor,
wherein the second controller decreases the frequency of the pulse signal in a case where the voltage detected by the detection unit is smaller than a voltage corresponding to the first voltage, and the second controller increases the frequency of the pulse signal in a case where the voltage detected by the detection unit is greater than the voltage corresponding to the first voltage, in the first power mode,
wherein the second controller decreases the frequency of the pulse signal in a case where the voltage detected by the detection unit is smaller than a voltage corresponding to the second voltage, and the second controller increases the frequency of the pulse signal in a case where the voltage detected by the detection unit is greater than the voltage corresponding to the second voltage and the determined frequency is smaller than the predetermined frequency, in the second power mode,
wherein the second controller stops the output of the pulse signal in a case where the voltage detected by the detection unit is greater than the voltage corresponding to the second voltage and the determined frequency is greater than the predetermined frequency, in the second power mode, and
wherein the second controller starts the output of the pulse signal in a case where the voltage detected by the detection unit and decreasing due to the stoppage of the output of the pulse signal reaches the voltage corresponding to the second voltage, in the second power mode.

10. The image forming apparatus according to claim 1,
wherein the smoothing capacitor is a first smoothing capacitor,
wherein the power supply device further includes a second smoothing capacitor configured to smooth the voltage generated in the second winding wire due to the voltage applied to the first winding wire, and
wherein the voltage smoothed by the second smoothing capacitor is output from the power supply device.

11. The image forming apparatus according to claim 1, wherein the power supply device outputs the voltage based on the alternate-current voltage output from the commercial power source, by a current resonance method.

12. The image forming apparatus according to claim 1, wherein the second controller determines a frequency greater than a resonance frequency at which the first winding wire and the capacitor resonate and smaller than the predetermined frequency, as the frequency of the pulse signal.

13. An image forming apparatus comprising:
an image forming unit configured to form an image on a recording medium;
a first controller configured to switch between a first power mode in which image formation by the image forming unit is enabled and a second power mode in which a number of loads supplied with power is less than a number of loads in the first power mode and power consumption is less than power consumption in the first power mode; and
a power supply device configured to convert an alternate-current voltage output from a commercial power source into a direct-current voltage, the power supply device including:
a rectification unit configured to rectify the alternate-current voltage output from the commercial power source;
a smoothing capacitor configured to smooth the voltage rectified by the rectification unit;
a transformer including a first winding wire to which the voltage smoothed by the smoothing capacitor is applied and a second winding wire insulated from the first winding wire;
a capacitor connected to the first winding wire in series;
a switching element connected to both the first winding wire and the capacitor in parallel; and
a second controller configured to determine a frequency of a pulse signal for switching between an on state and an off state of the switching element and to output the pulse signal of the determined frequency, the pulse signal being a signal in which a signal at a first level and a signal at a second level are repeated,
wherein the power supply device outputs a voltage based on a voltage generated in the second winding wire due to the voltage applied to the first winding wire,
wherein the second controller decreases the frequency of the pulse signal in a case where the voltage output from the power supply device is smaller than a first voltage, and the second controller increases the frequency of the pulse signal in a case where the voltage output from the power supply device is greater than the first voltage, in the first power mode,
wherein the second controller stops output of the pulse signal in a case where a power mode of the image forming apparatus is switched from the first power mode to the second power mode, and
wherein the second controller starts the output of the pulse signal in a case where the voltage output from the power supply device decreases due to stoppage of the output of the pulse signal and reaches a second voltage, in the second power mode, the second voltage being smaller than the first voltage.

14. The image forming apparatus according to claim 13, further comprising a conversion unit configured to lower the voltage output from the power supply device,
wherein the first controller operates at the voltage lowered by the conversion unit in the first power mode, and
wherein the first controller operates at the voltage output from the power supply device in the second power mode.

15. The image forming apparatus according to claim 14, wherein the voltage output from the power supply device is supplied to the first controller without being lowered by the conversion unit in the second power mode.

16. The image forming apparatus according to claim 13,
wherein the image forming unit includes a transfer unit configured to transfer an image to the recording medium, and
wherein the transfer unit transfers the image to the recording medium based on the voltage output from the power supply device in the first power mode.

17. The image forming apparatus according to claim 13, wherein the power is not supplied from the power supply device to the image forming unit in the second power mode.

18. The image forming apparatus according to claim 13, wherein the second controller starts the output of the pulse signal having a frequency less than or equal to the predetermined frequency in the case where the voltage output from the power supply device decreases due to the stoppage of the output of the pulse signal and reaches the second voltage, in the second power mode.

19. The image forming apparatus according to claim 18, wherein the second controller starts the output of the pulse signal having the predetermined frequency in the case where the voltage output from the power supply device decreases due to the stoppage of the output of the pulse signal and reaches the second voltage, in the second power mode.

20. The image forming apparatus according to claim 13,
wherein the switching element is a first switching element, and the power supply device further includes a second switching element connected to a resonance circuit in series and the first switching element in series, the resonance circuit including the first winding wire and the capacitor,
wherein the pulse signal is a first pulse signal, and the second controller determines a frequency of a second pulse signal for switching between an on state and an off state of the second switching element, and outputs the second pulse signal of the determined frequency, the second pulse signal being a signal in which a signal at a third level and a signal at a fourth level are periodically repeated,
wherein the second controller decreases the frequency of the second pulse signal in a case where the frequency of the first pulse signal is decreased, and the second controller increases the frequency of the second pulse signal in a case where the frequency of the first pulse signal is increased, and
wherein the second controller stops output of the second pulse signal in a case where the output of the first pulse signal is stopped.

21. The image forming apparatus according to claim 13,
wherein the smoothing capacitor is a first smoothing capacitor,
wherein the power supply device further includes:
a second smoothing capacitor configured to smooth the voltage generated in the second winding wire due to the voltage applied to the first winding wire; and
a detection unit configured to detect the voltage smoothed by the second smoothing capacitor,
wherein the second controller decreases the frequency of the pulse signal in a case where the voltage detected by the detection unit is smaller than a voltage corresponding to the first voltage, and the second controller increases the frequency of the pulse signal in a case where the voltage detected by the detection unit is greater than the voltage corresponding to the first voltage, in the first power mode, and
wherein the second controller starts the output of the pulse signal in a case where the voltage detected by the detection unit and decreasing due to the stoppage of the output of the pulse signal reaches a voltage corresponding to the second voltage, in the second power mode.

22. The image forming apparatus according to claim 13,
wherein the smoothing capacitor is a first smoothing capacitor,
wherein the power supply device further includes a second smoothing capacitor configured to smooth the voltage generated in the second winding wire due to the voltage applied to the first winding wire, and
wherein the voltage smoothed by the second smoothing capacitor is output from the power supply device.

23. The image forming apparatus according to claim 13, wherein the power supply device outputs the voltage based on the alternate-current voltage output from the commercial power source, by a current resonance method.

24. The image forming apparatus according to claim 13, wherein the second controller determines a frequency greater than a resonance frequency at which the first winding wire and the capacitor resonate and smaller than the predetermined frequency, as the frequency of the pulse signal.
